(19) United States
(12) Patent Application Publication
(10) Pub. No.: US 2013/0238750 A1
(43) Pub. Date: Sep. 12, 2013

(54) Method and Apparatus of Determining Redirection Quality, and Method and Apparatus of Placing Promotion Information

(71) Applicant: ALIBABA GROUP HOLDING LIMITED, Grand Cayman (KY)

(72) Inventors: Zhichao Fu, Hangzhou (CN); Xuesen Zang, Hangzhou (CN); Fanggui Jia, Hangzhou (CN)

(73) Assignee: ALIBABA GROUP HOLDING LIMITED, Grand Cayman (KY)

(21) Appl. No.: 13/786,247

(22) Filed: Mar. 5, 2013

(30) Foreign Application Priority Data
Mar. 8, 2012 (CN) 201210059345.5

(51) Int. Cl. H04L 29/08

(52) U.S. Cl. CPC H04L 29/0809
USPC 709/217

(57) ABSTRACT

A number of first jump visits that have been redirected by a jump server of a first website to a corresponding promotion web page in the first website through clicking of the promotion information displayed at a second website is counted. A number of second jump visits that have been redirected by a click server of the first website to a corresponding transaction web page through clicking of transaction information on the promotion web page is counted. A second jump visit rate for the promotion information is determined based on the counted number of the first jump visits and the counted number of second jump visits. The redirection quality of the promotion information is determined based on the determined second jump visit rate.

### CROSS REFERENCE TO RELATED PATENT APPLICATIONS

This application claims priority to Chinese Patent Application No. 201210059345.5, filed on Mar. 8, 2012, entitled “Method and Apparatus of Determining Redirection Quality, and Method and Apparatus of Placing Promotion Information,” which is hereby incorporated by reference in its entirety.

### TECHNICAL FIELD

The present disclosure relates to the field of information processing, and more particularly, relates to methods and apparatuses for determining redirection quality of promotion information and methods and apparatuses of placing the promotion information.

### BACKGROUND

In existing technologies, in order to draw more users to a website, the website may set up a promotion web page and corresponding promotion information thereof, and promulgate the promotion information to another website, i.e., posting the promotion information in a web page of the other website. When a user browses the web page of the other website, the user may click on the promotion information posted in the web page. A web browser used by the users may send a web page acquisition request to a jump server corresponding to that website. The web page acquisition request may include address information corresponding to the promotion web page. Upon receiving the web page acquisition request, the jump server may redirect a visit of the user from the web page of the other website to the corresponding promotion page based on the address information in the web page acquisition request. The web browser of the user displays the promotion web page to the user. Such promotion web page may also be called a landing page. Accordingly, users visiting other websites may be redirected to this website.

In existing technologies, after a user clicks on the promotion information posted in the other website and is drawn by the jump server to the promotion web page of the website, the user may select to close the promotion web page directly, without performing any further operations on the information in the promotion web page. Such a visit does not have much value to the website. However, in existing technologies, a website is unable to determine a quality of redirection related to promotion information that is posted in other websites (i.e., a value of visits which have been redirected by a jump server to the website due to clicking of the promotion information with respect to the website). Therefore, the website cannot determine whether to continue placing the promotion information in the other website. If the redirection quality of the promotion information that is placed in another website is poor (i.e., visits which have been redirected by the jump server to the website due to clicking of the promotion information is of less value to the website), the website needs to perform related operations for users' click operations if the promotion information is still placed therein. This not only lowers a utilization rate of processing resources of the website, but also impacts user experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In order to solve the problems of occupying processing resources of a website and increasing the burden of a communication network due to continued placement of promotion information that has very poor redirection quality, the present disclosure provides a method and an apparatus of determining redirection quality of promotion information, and a method and an apparatus of placing promotion information.

A technical scheme of the present disclosure is described as follows:

A method of determining a redirection quality of promotion information includes:

when a redirection quality of promotion information that is placed in a second website by a first website is to be determined, obtaining a first jump click log that is associated with a prescribed period of time from a jump server of the first website;

based on the obtained first jump click log, counting a number of first jump visits that have been redirected by the jump server to a corresponding promotion web page through clicking of the promotion information within the prescribed period of time;

obtaining a second jump click log that is associated with the prescribed period of time from a click server of the first website;

based on the obtained second jump click log and from among the first jump visits that have been redirected by the jump server to the corresponding promotion web page through the clicking of the promotion information within the prescribed period of time, counting a number of second jump visits that have been redirected by the click server to a corresponding transaction web page through clicking of transaction information on the promotion web page;

based on the counted number of the first jump visits and the counted number of second jump visits, determining a second jump visit rate for the promotion information; and

determining the redirection quality of the promotion information based on the determined second jump visit rate.

An apparatus of determining a redirection quality of promotion information includes:

a first jump click log acquisition unit, configured to obtain a first jump click log associated with a prescribed period of time from a jump server of a first website when a redirection quality of promotion information that is placed in a second website by the first website is to be determined;

a first jump visit number counting unit, configured to count a number of first jump visits that have been redirected by the jump server to a corresponding promotion web page due to clicking of the promotion information within the prescribed period of time based on the first jump click log obtained by the first jump click log obtaining unit;

a second jump click log acquisition unit, configured to obtain a second jump click log from a click server of the first website;

a second jump visit number counting unit, configured to count, from among the first jump visits that have been redirected by the jump server to the corresponding promotion web page due to the clicking of the promotion information within the prescribed period of time, a number of the second jump visits that have been redirected by a click server to a corresponding transaction web page due to clicking of transaction information in the promotion web page based on the second jump click log obtained by the second jump click log acquisition unit;

a second jump visit rate determination unit, configured to determine a second jump visit rate of the promotion information based on the number of the first jump visits counted by the first jump visit number counting unit and the number of the second jump visits counted by the second jump visit number counting unit; and

a redirection quality determination unit, configured to determine a redirection quality of the promotion information based on the second jump visit rate determined by the second jump visit rate determination unit.

A method of placing promotion information includes:

obtaining a redirection quality of promotion information that is placed in a second website by a first website; and

affirming to continue to place the promotion information on the second website when the redirection quality meets a pre-determined placement criterion, where the redirection quality of the promotion information is determined using the aforementioned method of determining a redirection quality of promotion information.

An apparatus of placing promotion information includes:

a redirection quality acquisition unit, configured to obtain a redirection quality of promotion information that is placed in a second website by a first website; and

a promotion information placement affirmation unit, configured to affirm to continue placement of the promotion information on the second website when the redirection quality obtained by the redirection quality acquisition unit meets a pre-determined placement criterion, wherein the redirection quality is determined by the aforementioned apparatus of determining a redirection quality of promotion information.

The exemplary embodiments obtain a first jump click log that is associated with a prescribed period of time from a jump server of a first website when a redirection quality of promotion information that is placed in a second website by the first website is to be determined; based on the obtained first jump click log, count a number of first jump visits that have been redirected by the jump server to a corresponding promotion web page through clicking of the promotion information within the prescribed period of time; obtain a second jump click log associated with the prescribed period of time from a click server of the first website; from among the first jump visits that have been redirected by the jump server to the corresponding promotion web page through the clicking of the promotion information within the prescribed period of time based on the obtained second jump click log, count a number of second jump visits that have been redirected by the click server to a corresponding transaction web page through clicking of transaction information on the promotion web page based on the obtained second jump click log; based on the counted number of the first jump visits and the counted number of second jump visits, determine a second jump visit rate of the promotion information; and determine the redirection quality of the promotion information based on the determined second jump visit rate. If a user clicks on promotion information (which has been placed by the first website on the second website and for which a redirection quality is to be determined) and is redirected by the jump server to a corresponding promotion web page, a first jump visit as described above is generated. If the user clicks on transaction information in the promotion web page and is redirected by the click server to a corresponding transaction web page, a second jump visit as described above is generated. Since the user clicks the transaction information in the promotion web page, the second jump visit is more valuable to the first website. Therefore, the redirection quality of the promotion information may be determined based on the second jump visit rate. In other words, a value of the visit that has been redirected by the jump server to the first website due to the clicking of the promotion information may be determined. Thereafter, when the first website needs to determine whether to continue the placement of the promotion information on the second website, the redirection quality of the promotion information (that is placed in the second website by the first website) may be obtained first. A confirmation of continuing to place the promotion information in the second website may be made if the redirection quality meets a pre-determined placement criterion. This avoids the scenario that the first website still places the promotion information in the second website even though the redirection quality is very poor. Therefore, a utilization rate of processing resources of the first website may be effectively improved, thus preventing the poor redirection quality of the promotion information from affecting user experience.

### BRIEF DESCRIPTION OF THE DRAWINGS

FIG. 1 is a flowchart illustrating a process of redirection performed by a first website due to a user's click in accordance with a first embodiment of the present disclosure.

FIG. 2 is a flowchart illustrating a method of determining a redirection quality of promotion information in accordance with a second embodiment of the present disclosure.

FIG. 3 is a schematic diagram illustrating a principle of determining a revenue ratio between a first website and a second website with respect to promotion information in accordance with the second embodiment of the present disclosure.

FIG. 4 is a schematic diagram illustrating a principle of redirection performed by a first website due to a user's click in accordance with the second embodiment of the present disclosure.

FIG. 5 is a flowchart illustrating a method of placing promotion information in accordance with a third embodiment of the present disclosure.

FIG. 6 is a schematic diagram illustrating an apparatus of determining a redirection quality of promotion information in accordance with a fourth embodiment of the present disclosure.

FIG. 7 is a schematic diagram illustrating an apparatus of placing promotion information in accordance with a fifth embodiment of the present disclosure.

FIG. 8 is a structural diagram illustrating the example apparatus as described in FIGS. 6 and 7.

### DETAILED DESCRIPTION

Main implementation principles, specific implementation methods and benefits of the technical scheme of the exemplary embodiments of the present disclosure are described in details below with the help of the accompanying figures.

In the exemplary embodiments, a website that places promotion information is called a first website, and a website in which promotion information is placed is called a second website.

The embodiments include an online handling process in which the first website performs a redirection based on a click of a user, an offline handling process in which the first website determines a redirection quality of promotion information, and an offline handling process in which the first website determines whether to continue placement of the promotion information based on the redirection quality of the promotion information. The online handling process in which the first website performs the redirection based on a click of a user is introduced first as follows.

### First Embodiment

With an intention of drawing more users to the first website, the first website may set up a promotion web page and promotion information corresponding to the promotion web page. The promotion information may be a certain picture or a certain text segment, etc. The promotion information may then be placed in the second website, i.e., posting the promotion information in a web page of the second website. When a user browses the web page of the second website, the user may click on the promotion information in the web page of the second website. A jump server of the first website may redirect a visit of the user from the web page of the second website to the promotion web page.

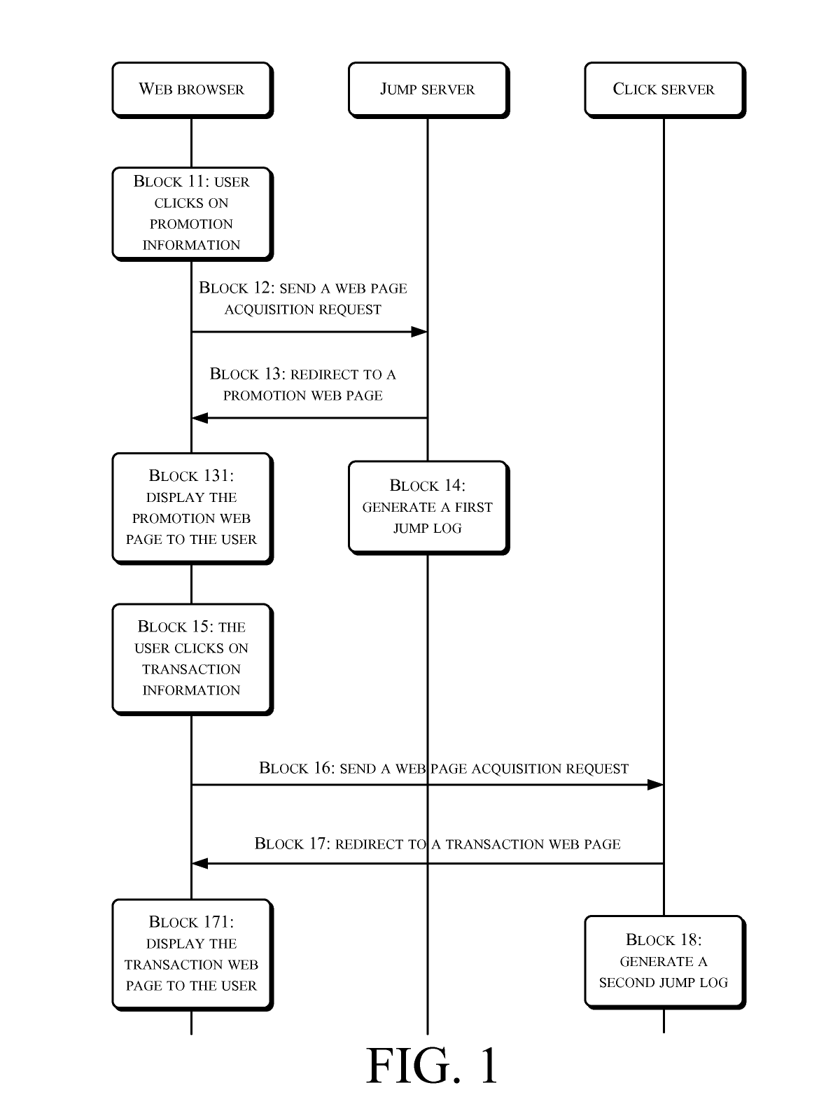

FIG. 1 is a diagram illustrating a process of redirection performed by a first website in response to a click of a user in accordance with the first embodiment of the present disclosure. A process thereof includes:

At block 11, when browsing a web page of the second website, a user may click on promotion information that is posted by a first website in a web page of the second website.

At block 12, a web browser 2 used by the user may send a web page acquisition request to a jump server corresponding to the first website. The web page acquisition request may include address information of a promotion web page corresponding to the promotion information that is clicked by the user, and an identifier of the promotion information.

The identifier of the promotion information may include, but not limited to, a reference publish identity (refPID; PID: publish Identity) corresponding to the promotion information. The first website may use the refPID to uniquely identify a certain piece of promotion information that is placed in the second website. When a same piece of promotion information is placed in different second websites, refPIDs that correspond to the promotion information placed in the second websites are different with each other. A refPID corresponding to the promotion information therefore includes a website identifier of a corresponding second website. Based on the website identifier included in the refPID of the promotion information, a second website in which the promotion information is placed may be determined.

The web page acquisition request may further include a keyword corresponding to the promotion information. The keyword that corresponds to the promotion information may include, but not limited to, category information of the promotion information, etc.

At block 13, the jump server 4 redirects a visit of the user to the promotion web page corresponding to the promotion information that is clicked by the user based on the address information included in the web page acquisition request. The web browser 2 of the user displays the promotion web page to the user at block 131. This promotion web page may also be called a “Landing Page”.

Through this redirection by the jump server 4, the user who browses the second website may be successfully redirected to the promotion web page of the first website.

Moreover, after receiving the web page acquisition request, the jump server 4 may authenticate the promotion information based on the keyword included in the webpage access request, verifying whether the promotion information is authorized for redirection. Specifically, permission information of the promotion information may be found based on the keyword included in the web page acquisition request and a determination may be made as to whether the promotion information is authorized for redirection based on the permission information. If the jump server 4 successfully authenticates the promotion information, i.e., verifying that the promotion information has the permission to perform redirection, block 13 may be performed. If the promotion information fails the authentication, no operations may need to be performed.

At block 14, the jump server 4 generates a visit record for this click operation (called as a first jump visit record), and stores the generated first jump visit record in a first jump click log. The first jump visit record that is generated by the jump server may include the identifier of the promotion information that has been clicked by the user (such as the refPID corresponding to the promotion information), which is used to represent a source of this first jump visit, i.e., from which second website the first jump visit is redirected to the promotion web page of the first website.

The first jump click log in the first embodiment of the present disclosure may include, but not limited to, what are shown in Table 1.

TABLE 1

| | |
|---|---|
| First jump visit record 1 | refPID1 |
| First jump visit record 2 | refPID2 |
| First jump visit record 3 | refPID3 |
| First jump visit record 4 | refPID4 |
| First jump visit record 5 | refPID5 |

The first jump visit record may further include information of time that corresponds to this click operation.

Block 13 and block 14 may be performed in parallel or in series. An order of execution thereof is not limited herein.

At block 15, the promotion web page may include multiple pieces of transaction information, with each piece of transaction information corresponding to a transaction web page. When browsing the promotion web page, the user may click on transaction information in the promotion web page.

At block 16, the web browser 2 used by the user sends a web page acquisition request to a click server 6 corresponding to the first website. This web page acquisition request may include an identifier of transaction information clicked by the user, website address information of a transaction web page corresponding to the transaction information clicked by the user, an identifier of the promotion information (refPID) corresponding to the promotion web page, and a transaction identifier corresponding to the transaction web page.

The identifier of the transaction information may include, but not limited to, a PID corresponding to the transaction information. The first website uses the PID to uniquely identify a certain piece of transaction information on the promotion web page. If a same piece of transaction information is included in different promotion web pages, a PID of that piece of transaction information in each promotion web page is different from others. As such, a PID of transaction information may include a web page identifier of a corresponding promotion web page. A promotion web page including the transaction information may be determined based on the web page identifier included in the PID of the promotion web page.

If the first website is an e-commerce website, transaction information included in the promotion web page may include, but not limited to, advertising information set up by a seller of the e-commerce website, e.g., a certain picture or text segment set up by the seller. The transaction web page corresponding to the transaction information may include product information of the seller. In this case, the transaction identifier corresponding to the transaction web page may be an identifier of the product information.

At block 17, the click server 6 redirects the user's visit to the transaction web page that corresponds to the transaction information clicked by the user based on the address information included in the web page acquisition request. The web browser of the user displays the transaction web page to the user at block 171.

This redirection by the click server 6 can successfully redirect the user of the second website to a specific transaction web page.

At block 18, the click server 6 generates a visit record (called as a second jump visit record) corresponding to this click operation and stores the second jump visit record in a second jump click log. The second jump visit record generated by the jump server 4 may include the identifier of the transaction information (PID) clicked by the user, the identifier of the promotion information (refPID) corresponding to the promotion web page, and the transaction identifier of the transaction web page.

The second jump click log in this first embodiment of the present disclosure may include, but not limited to, what are shown in Table 2.

TABLE 2

| | | | |
|---|---|---|---|
| Second jump visit record 1 | PID1 | refPID1 | Transaction identifier 1 |
| Second jump visit record 2 | PID2 | refPID2 | Transaction identifier 2 |
| Second jump visit record 3 | PID3 | refPID3 | Transaction identifier 3 |
| Second jump visit record 4 | PID4 | refPID4 | Transaction identifier 4 |
| Second jump visit record 5 | PID5 | refPID5 | Transaction identifier 5 |

The second jump visit record may further include information of time that corresponds to the click operation.

The identifier of the promotion information (refPID) is used to show a source of the second website that is associated with the second jump visit, i.e., from which second website the promotion web page (from which the second jump visit is redirected to the transaction web page) of the first website has been redirected. The identifier of the transaction information is used to show a source of the promotion web page that is associated with the second jump visit, i.e., from which promotion webpage the second jump visit is redirected to the transaction web page. The transaction identifier corresponding to the transaction web page is used to show a target transaction of the second jump visit, i.e., a transaction that is targeted by the second jump visit. If the first website is an e-commerce website, the transaction identifier of the transaction web page may represent product information that is targeted by the second jump visit.

Block 17 and block 18 may be performed in parallel or in series. An order of execution thereof is not limited herein.

Accordingly, through the redirection process performed by the first website for the user's click in this first embodiment, the jump server 4 of the first website stores the first jump click log, and the click server 6 of the first website stores the second jump click log.

An offline handling process of determining a redirection quality of promotion information is described as follows.

### Second Embodiment

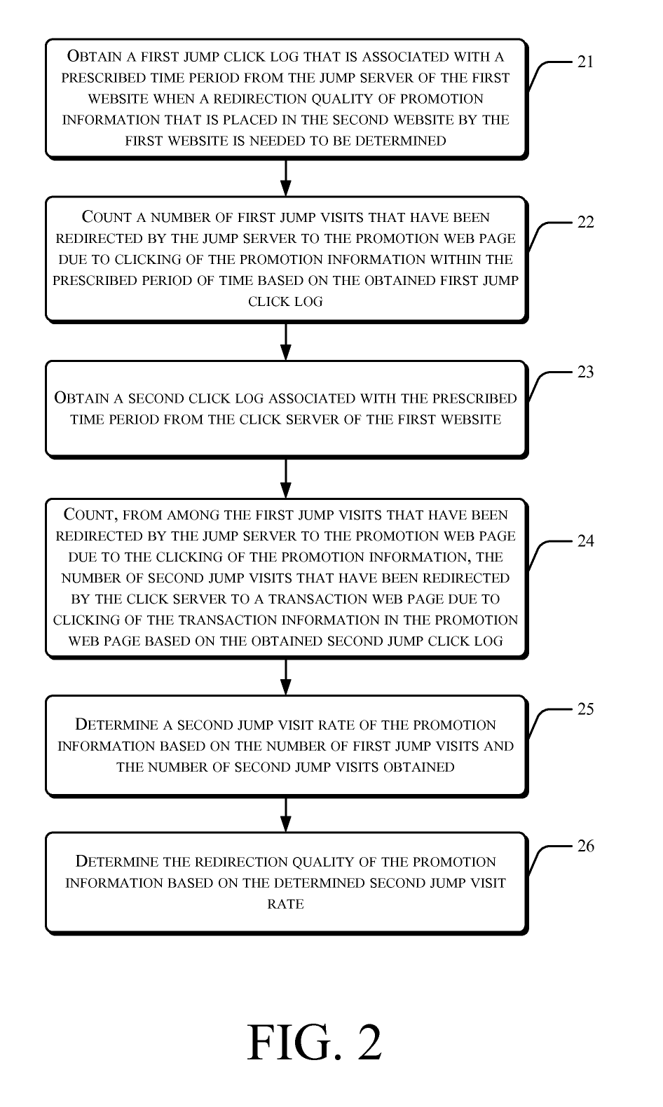

FIG. 2 is a flowchart illustrating a method of determining a redirection quality of promotion information, which includes:

Block 21 obtains a first jump click log that is associated with a prescribed time period from the jump server of the first website when a redirection quality of promotion information that is placed in the second website by the first website is needed to be determined.

If a redirection quality of promotion information that is placed by the first website in the second website within a prescribed period of time is needed to be determined, a first jump click log associated with the prescribed period of time may be obtained from the jump server of the first website. According to the first embodiment, the first jump click log may include a first jump visit record generated each time when a user clicks on the promotion information of the first website. The first jump visit record may include an identifier of the promotion information (refPID) clicked by a user.

In the second embodiment, the prescribed time period may be defined according to needs, e.g., one month, etc.

Block 22 counts a number of first jump visits that have been redirected by the jump server to the promotion web page due to clicking of the promotion information within the prescribed period of time based on the obtained first jump click log.

After obtaining the first jump click log, the number of first jump visit records (in the first jump click log) which contains the identifier (refPID) of the promotion information of which the quality of redirection needs to be determined is counted. In other words, how many first jump visit records including the identifier (refPID) of the promotion information of which the redirection quality is to be determined are counted. If a first jump visit record contains the identifier of the promotion information (refPID) of which the redirection quality is to be determined, it may be deemed that the jump server generates and stores that first jump visit record after the user clicks on the promotion information of which the redirection quality is to be determined. Therefore, the counted number of first jump visit records may be recognized as the number of first jump visits that have been redirected by the jump server to the corresponding promotion web page within the prescribed time period due to clicking of the promotion information of which the redirection quality is to be determined.

If the identifier of the promotion information of which the redirection quality is to be determined is refPID5 and the number of the first jump visit records that contain refPID5 in the first jump click log is 100, the number of first jump visits that have been redirected by the jump server to the corresponding promotion web page within the prescribed time period due to clicking of the promotion information of which the redirection quality is to be determined is counted to be 100.

Block 23 obtains a second click log associated with the prescribed time period from the click server of the first website.

If the redirection quality of the promotion information that is placed on the second website by the first website within the prescribed time period is needed to be determined, the second jump click log that is associated with the prescribed time period may be obtained from the click server of the first website. According to the first embodiment of the present disclosure, the second jump click log may include a second jump visit record generated each time when a user clicks on transaction information on the promotion web page. The second visit record may include an identifier of the transaction information (PID) clicked by a user and an identifier of the promotion information (refPID).

Block 24 counts, from among the first jump visits that have been redirected by the jump server to the promotion web page due to the clicking of the promotion information, the number of second jump visits that have been redirected by the click server to a transaction web page due to clicking of the transaction information in the promotion web page based on the obtained second jump click log.

After obtaining the second jump click log, identifiers of various pieces of transaction information (PID) in the promotion web page are first obtained. Specifically, the web page identifier of the promotion web page to which the promotion information (of which the redirection quality is to be determined) belonged is first obtained. Since an identifier of transaction information (PID) in the promotion web page includes the web page identifier of the promotion web page, identifiers of transaction information that include the identifier of the promotion web page may be found from all identifiers of transaction information. The number of second visit records which contain the identifier of the promotion information (refPID) of which the redirection quality is to be determined and the obtained identifiers of the transaction information (PID) is obtained from the obtained second click log. In other words, how many second jump visit records that contain the identifier of the promotion information (refPID) and the identifiers of the transaction information (PID) are counted. If a second visit record contains the identifier of the promotion information (refPID) of which the redirection quality is to be determined and an identifier of transaction information (PID) that is included in the promotion web page, it may be deemed that the jump server redirects the user's visit to the promotion web page that corresponds to the promotion information after the user clicks on the promotion information of which the redirection quality is to be determined, and the click server then generates and stores the second jump visit record after the user clicks on the transaction information on the promotion web page. Therefore, the counted number of second jump visit records may be recognized as the number of second jump visits that have been redirected to the transaction web page by the click server due to clicking of the transaction information on the promotion web page within the prescribed time period, from among the first jump visits that have been redirected to the promotion web page by the jump server due to clicking of the promotion information.

In this second embodiment, block 21 and block 22 may be performed in parallel or in series. An order of execution thereof is not limited herein.

Block 25 determines a second jump visit rate of the promotion information based on the number of first jump visits and the number of second jump visits obtained.

A quotient between the number of second jump visits and the number of first jump visits may be treated as the second jump visit rate of the promotion information.

If, for example, the promotion information of which the redirection quality is to be determined is promotion information A, the number of second jump visits that is obtained at block 24 is N2, and the number of first jump visits that is obtained at block 22 is N2, then the second jump visit rate of the promotion information A is N=N2/N1.

Block 26 determines the redirection quality of the promotion information based on the determined second jump visit rate.

In this second embodiment, second jump visit rate ranges corresponding to different redirection qualities may be determined in advance. After determining the second jump visit rate of the promotion information, a second jump visit rate range within which the determined second jump visit rate is located may be determined and found from the second jump rate ranges corresponding to the redirection qualities, and the located second jump visit rate range is treated as the redirection quality of the promotion information.

For example, there may be three types of redirection quality associated with promotion information: good, average and bad. Of which, the “good” redirection quality corresponds to a second jump visit rate range of (1, 0.7], the “average” redirection quality corresponds to a second jump visit rate range of (0.7, 0.3), and the “bad” redirection quality correspond to a second jump visit rate range of [0.3, 0). If the second jump visit rate that is determined at block 25 is 0.5, which is located within the second jump visit rate range of (0.7, 0.3), the redirection quality of the promotion information is “average”.

Furthermore, the first website needs to pay a fee to the second website if the first website wants to post promotion information in the second website. In existing technologies, the first website usually pays a fixed fee to the second website, e.g., a monthly fixed fee. However, for the second website, such an approach means that a portion in the web page is rented for the promotion information at a fixed price. Even if many users have been redirected to corresponding promotion web page due to clicking of the promotion information, the fee paid by the first website for the promotion information remains unchanged. Therefore, the revenue of the second website may not be maximized. Also, for the first website, this approach returns a poor value for visits redirected to the first website if the redirection quality of the promotion information is poor.

If the first website is an e-commerce website, transaction information in the promotion web page may be set up by a seller. If a user clicks on the transaction information in the promotion web page, the click server may redirect the user's visit to a corresponding transaction web page which may include information of a product of the seller. The seller may need to pay a certain amount of a fee to the first website in order to put the transaction information in the promotion web page.

In order to improve the revenue of the second website and provide the first website a better quality of redirection, the second embodiment proposes determining a revenue ratio between the first website and the second website with respect to promotion information based on a second jump visit rate of the promotion information that is placed in the second website by the first website. The revenue ratio described herein refers to a ratio of fees obtained separately by the first website and the second website each time when a seller is charged for a fee due to a user click on the transaction information associated with the seller.

In this second embodiment, when the user browses the second website and clicks on the promotion information that is placed in the second website by the first website, the jump server may redirect the user's visit to a corresponding promotion web page. At this time, the first website does not charge a seller of transaction information in the promotion web page. When the user browses the promotion web page and clicks on the transaction information that is set up by the seller on the promotion web page, the click server redirects the user's visit to a corresponding transaction web page. At this time, the first website charges a fee to the seller corresponding to the transaction information that has been clicked by the user. Fees corresponding to different pieces of transaction information may be different. The click server of the first website stores correspondence relationships between transaction identifiers of transaction web pages and information of fees to be charged. The click server may find information of a fee that is to be charged to the seller based on the above correspondence relationships using an identifier of the transaction web page that corresponds to the transaction information clicked by the user. A transaction identifier of a transaction web page may be an identifier of product information included in the transaction web page.

The first website may periodically determine revenue information of the first website regarding second jump visits that correspond to promotion information placed in the second website and revenue information of the second website regarding the second jump visits corresponding to the promotion information. Specifically, fee information corresponding to each second jump visit (i.e., second jump visits that are redirected by the click server to the transaction web page due to clicking of transaction information on a promotion web page from among first jump visits redirected by the jump server to the promotion information web page due to clicking of promotion information of which the redirection quality is to be determined) during a prescribed time period is determined based on obtained second jump click log. For each second jump visit, revenue information of the first website and revenue information of the second website due to the second jump visit is determined based on the fee information corresponding to the second jump visit and the revenue ratio between the first website and the second website with respect to the promotion information, i.e., information of revenues respectively obtained by the first website and the second website from each second jump visit.

In the second embodiment, when a user clicks on transaction information in a promotion web page, the click server not only stores an identifier of the transaction information (PID) clicked by the user and an identifier of associated promotion information (refPID) in a second jump visit record of this second jump visit, but also stores an identifier of the transaction web page that corresponds to the transaction information clicked by the user. Upon determining fee information corresponding to the second jump visit, identifiers of various pieces of transaction information (PID) belonging to the promotion web page that corresponds to the promotion information may first be obtained. Specifically, a web page identifier of the promotion web page to which the promotion information belongs may be determined first. Since an identifier of transaction information (PID) in the promotion web page includes the web page identifier of the promotion web page, identifiers of transaction information which contain the web page identifier of the promotion web page may be found from among all identifiers of transaction information. Thereafter, from an obtained second jump click log, second jump visit records that include the identifier (refPID) of the promotion information and the obtained identifiers (PID) of the transaction information are determined. In other words, how many second jump visit records include both the identifier (refPID) of the promotion information and the obtained identifiers (PID) of the transaction information are counted. For each determined second jump visit record, based on a transaction identifier of transaction information contained in the second jump visit record, fee information corresponding to the transaction identifier is found from correspondence relationships between service identifiers and information of fees, and fee information of the second jump visit corresponding to the second jump visit record is obtained, i.e., information of a fee to be charged to a seller due to this second jump visit.

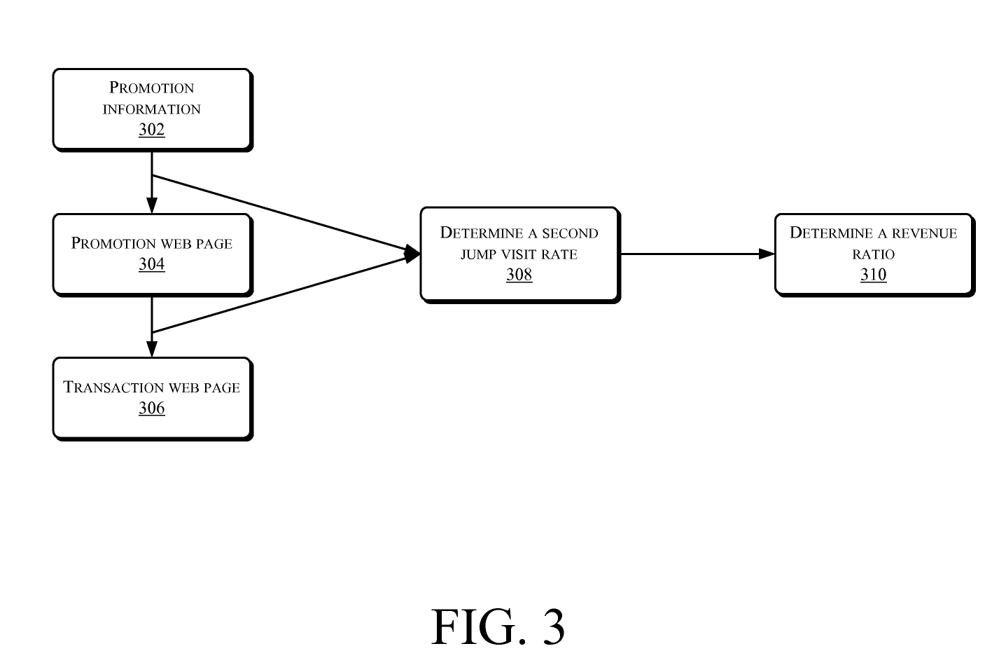

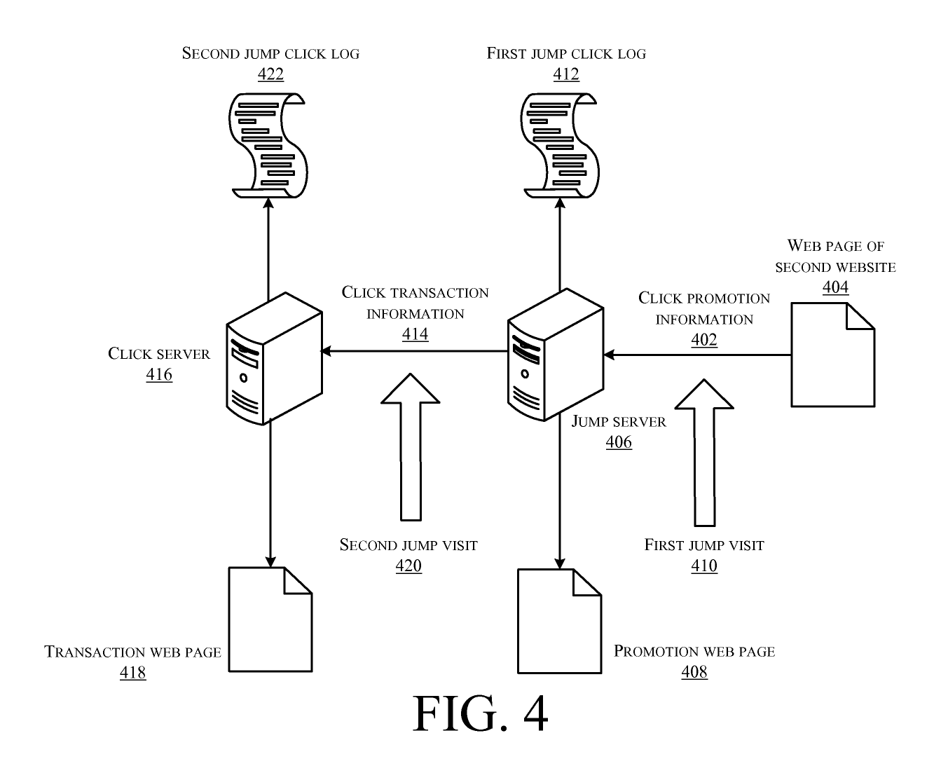

FIG. 3 is a schematic diagram illustrating a principle of determining a revenue ratio between the first website and the second website with respect to promotion information in accordance with the second embodiment of the present disclosure. After a user clicks on promotion information 302 placed by the first website on the second website, a visit of the user is redirected to a promotion web page 304 that corresponds to the promotion information. If the user clicks on transaction information in the promotion web page 304, the visit of the user is redirected to a transaction web page 306 corresponding to the transaction information. A second jump visit rate 308 is determined, and a revenue ratio 310 is determined based on the second jump visit rate as described in the foregoing embodiments. FIG. 4 is a schematic diagram illustrating a principle of redirection performed by the first website for a user's click in accordance with the second embodiment of the present disclosure. The user clicks on promotion information 402 placed by the first website on the second website 404. The jump server 406 of the first website redirects the user's visit to a promotion web page 408 corresponding to the promotion information 402. Such visit is called a first jump visit 410. The jump server 406 also generates and stores a first jump click log 412. The first jump click log 412 includes a first jump visit record generated each time when a user clicks on the promotion information 402. The first jump visit record includes an identifier of the promotion information 402 (refPID). When browsing the promotion web page 408, the user may click on transaction information 414 in the promotion web page 408. The click server 416 of the first website redirects the user's visit to a transaction web page 418 that corresponds to the transaction information 414. Such visit is called a second jump visit 420. The click server 416 also generates and stores a second jump click log 422. The second jump click log 422 includes a second jump visit record generated each time when a user clicks the transaction information 414. The second jump visit record includes the identifier of the promotion information 402 (refPID), an identifier of the transaction information 414 (PID) clicked by the user and a transaction identifier of the transaction web page 418 corresponding to the transaction information 414. A second jump visit rate may be determined based on the first jump click log 412 and the second jump click log 422. A revenue ratio between the first website and the second website with respect to the promotion information 402 may be determined based on the second jump visit rate. Further, the click server 416 may also determine fee information corresponding to this second jump visit based on the transaction identifier contained in the second jump visit record, i.e., information of a fee to be charged to a corresponding seller. Therefore, information of respective revenues of the first website and the second website with respect to this second jump visit may be determined based on the fee information and the revenue ratio.

An offline handling process of determining whether to continue placing promotion information based on a redirection quality of the promotion information is described as follows.

### Third Embodiment

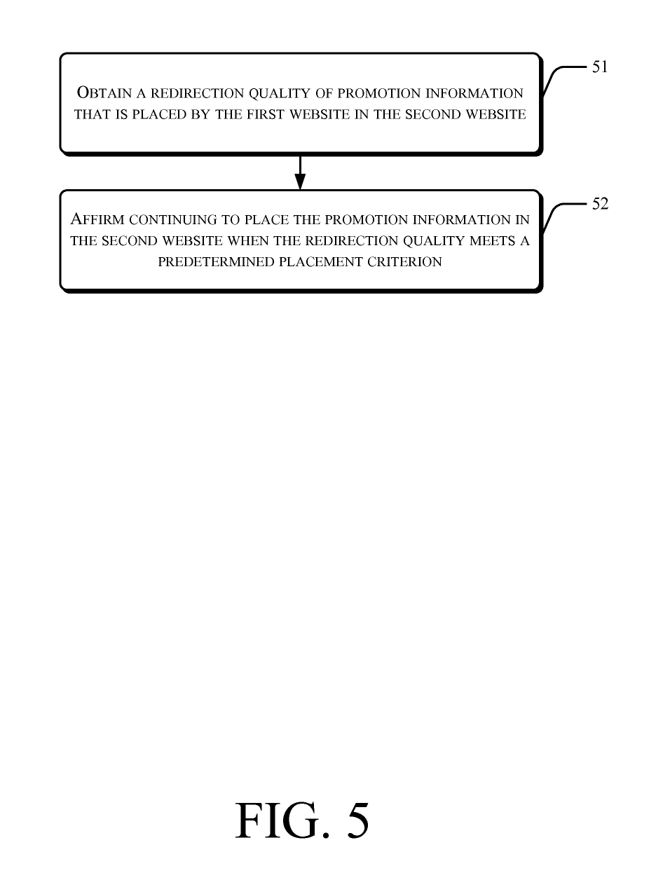

FIG. 5 is a flowchart illustrating a method of placing promotion information in accordance with the third embodiment of the present disclosure. Specifically, a process thereof includes:

Block 51 obtains a redirection quality of promotion information that is placed by the first website in the second website.

After the promotion information has been placed by the first website in the second website, a redirection quality of the promotion information within a prescribed time period may be determined using the method of determining a redirection quality of promotion information as described in the second embodiment.

Block 52 affirms continuing to place the promotion information in the second website when the redirection quality meets a predetermined placement criterion.

In this third embodiment, if the redirection quality meets a predetermined placement criterion, the first website may continue to place the promotion information in the second website. If the redirection quality fails to meet the predetermined placement criterion, the first website does not need to continue the placement of the promotion information in the second website.

A redirection quality of promotion information may include, but not limited to: good, average and bad. The place criterion may be set as “good”. Specifically, if the redirection quality of the promotion information is good, the first website may continue to place the promotion information in the second website If the redirection quality of the promotion information is average or bad, the first website does not need to continue to place the promotion information in the second website.

As can be seem from the above handling process, this exemplary embodiment first obtains, from the jump server of the first website, a first jump click log associated with a prescribed period of time when a redirection quality of promotion information that is placed in the second website by the first website is to be determined; based on the obtained first jump click log, counts a number of first jump visits that have been redirected by the jump server to a corresponding promotion web page through clicking of the promotion information within the prescribed period of time; obtains a second jump click log associated with the prescribed period of time from the click server of the first website; from among the first jump visits that have been redirected by the jump server to the corresponding promotion web page through the clicking of the promotion information within the prescribed period of time, counts a number of second jump visits that have been redirected by the click server to a corresponding transaction web page through clicking of transaction information on the promotion web page based on the obtained second jump click log; based on the counted number of the first jump visits and the counted number of second jump visits, determines a second jump visit rate of the promotion information; and determines the quality of redirecting the promotion information based on the determined second jump visit rate. If a user clicks on promotion information (which has been placed by the first website in the second website and of which a redirection quality is to be determined) and is redirected by the jump server to a corresponding promotion web page, a first jump visit as described above is generated. If the user clicks on transaction information in the promotion web page and is redirected by the click server to a corresponding transaction web page, a second jump visit as described above is generated. Since the user clicks on the transaction information in the promotion web page, the second jump visit is more valuable to the first website. Therefore, the redirection quality of the promotion information may be determined based on the second jump visit rate. In other words, a value of the visit that is redirected by the jump server to the first website due to the clicking of the promotion information may be determined. Thereafter, when the first website needs to determine whether to continue to place the promotion information in the second website, the redirection quality of the promotion information that is placed by the first website in the second website may first be obtained. A confirmation of continuing to place the promotion information in the second website may be made when the redirection quality meets a pre-determined placement criterion. This avoids the scenario that the first website still places the promotion information in the second website even though the redirection quality is very poor. Therefore, a utilization rate of processing resources of the first website may be effectively improved, thus preventing the poor redirection quality of the promotion information from affecting user experience.

### Fourth Embodiment

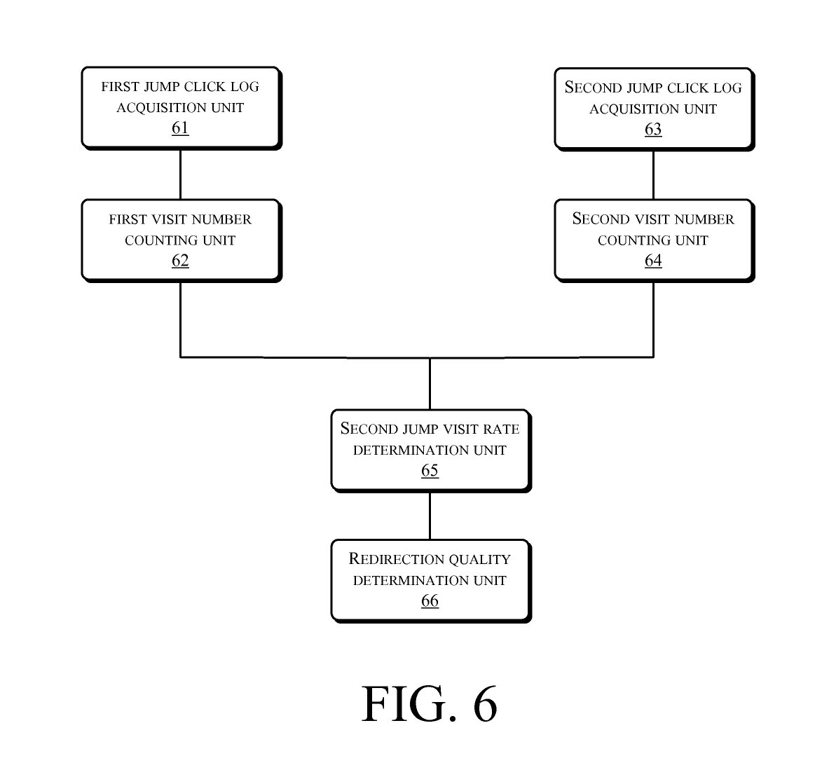

Corresponding to the method of determining a redirection quality of promotion information as described in the second embodiment of the present disclosure, a fourth embodiment of the present disclosure provides an apparatus of determining a redirection quality of promotion information. A structure thereof is shown in FIG. 6, which includes:

a first jump click log acquisition unit 61, configured to obtain a first jump click log associated with a prescribed period of time from a jump server of a first website when a redirection quality of promotion information that is placed in a second website by the first website is to be determined;

a first jump visit number counting unit 62, configured to count a number of first jump visits that have been redirected by the jump server to a corresponding promotion web page due to clicking of the promotion information within the prescribed period of time based on the first jump click log obtained by the first jump click log obtaining unit 61;

a second jump click log acquisition unit 63, configured to obtain a second jump click log from a click server of the first website;

a second jump visit number counting unit 64, configured to count, from among the first jump visits that have been redirected by the jump server to the corresponding promotion web page due to the clicking of the promotion information within the prescribed period of time, a number of the second jump visits that have been redirected by a click server to a corresponding transaction web page due to clicking of transaction information on the promotion web page based on the second jump click log obtained by the second jump click log acquisition unit 63;

a second jump visit rate determination unit 65, configured to determine a second jump visit rate of the promotion information based on the number of the first jump visits counted by the first jump visit number counting unit 62 and the number of the second jump visits counted by the second jump visit number counting unit 64; and

a redirection quality determination unit 66, configured to determine a redirection quality of the promotion information based on the second jump visit rate determined by the second jump visit rate determination unit 65.

In one embodiment, the second jump visit rate determination unit 65 may further be configured to use a quotient value between the number of the second jump visits counted by the second jump visit counting unit 64 and the number of the first jump visits counted by the first jump visit counting unit 62 as the second jump visit rate of the promotion information.

In some embodiments, the apparatus may further include a revenue ratio determination unit that is configured to determine a revenue ratio between the first website and the second website with respect to the promotion information based on the second jump visit rate determined by the second jump visit rate determination unit 65.

In one embodiment, the apparatus may further include:

a fee information determination unit, configured to determine fee information corresponding to each second jump visit within the prescribed time period based on the second jump click log obtained by the second jump click log acquisition unit 63; and

a revenue information determination unit, configured to determine information of respective revenues for the first website and the second website with respect to each second jump visit based on the fee information determined by the fee information determination unit and the revenue ratio determined by the revenue ratio determination unit.

In some embodiments, the second jump click log may include a second jump visit record generated each time when a user clicks on the transaction information in the promotion web page. The second jump visit record includes an identifier of the transaction information clicked by the user, an identifier of the promotion information, and a transaction identifier of a transaction web page corresponding to the transaction information clicked by the user.

The fee information determination unit may include:

a first transaction information identifier acquisition sub-unit, configured to obtain identifiers of various pieces of transaction information in the promotion web page;

a second jump visit record determination sub-unit, configured to determine the second jump visit records that include the identifier of promotion information of which the redirection quality is to be determined and the identifiers of the transaction information obtained by the first transaction information identifier acquisition unit from the second jump click log that is obtained by the second jump click log acquisition unit 63; and

a fee information determination sub-unit, configured to, for each second jump visit records determined by the second jump visit record determination sub unit, determine fee information of a second jump visit corresponding to the second jump visit record based on a transaction identifier included in the second jump visit record.

In some embodiments, the first jump click log includes a first jump visit record generated each time when a user clicks on the promotion information of the first website. The first jump visit record includes the identifier of the promotion information clicked by the user.

The first jump visit counting unit 62 may include:

a first jump visit record counting sub-unit, configured to count a number of the first jump visit records which contain the identifier of the promotion information from the first jump click clog that is obtained by the first jump click log acquisition unit 61; and

a first jump visit number affirmation sub-unit, configured to treat the number of first jump visit records counted by the first jump visit record counting sub-unit as the number of first jump visits redirected by the jump server to the corresponding promotion web page within the prescribed time period due to the clicking of the promotion information.

The second jump click log may include a second jump visit record generated each time when a user clicks on the transaction information in the promotion web page. The second jump visit record includes the identifier of the transaction information clicked by the user and the identifier of the promotion information.

The second jump visit counting unit 64 may include:

a second service information identifier acquisition sub-unit, configured to obtain identifiers of various pieces of transaction information on the promotion web page;

a second jump visit records counting sub-unit, configured to determine a number of the second jump visit records which contain the identifier of promotion information of which the redirection quality is to be determined and the identifiers of the transaction information obtained by the second service information identifier acquisition sub-unit from the second jump click log that is obtained by the second jump click log acquisition unit 63; and

a second jump visit number affirmation sub-unit, configured to treat the number of the second jump visit records obtained by the second jump visit record counting sub-unit as the number of second jump visits redirected by the click server to the corresponding transaction web page due to the clicking of the transaction information in the promotion web page within the prescribed time period, from among the first jump visits redirected by the jump server to the corresponding promotion web page due to the clicking of the promotion information.

In one embodiment, the redirection quality determination unit 66 may include:

a second jump visit rate range searching sub-unit, configured to find a second jump visit rate range within which the second jump visit rate determined by the second jump visit rate determination unit 65 is positioned from among pre-determined second jump rate ranges that correspond to various redirection qualities; and

a redirection quality affirmation sub-unit, configured to treat the second jump visit rate range found by the second jump visit rate range searching sub-unit as the redirection quality of the promotion information.

### Fifth Embodiment

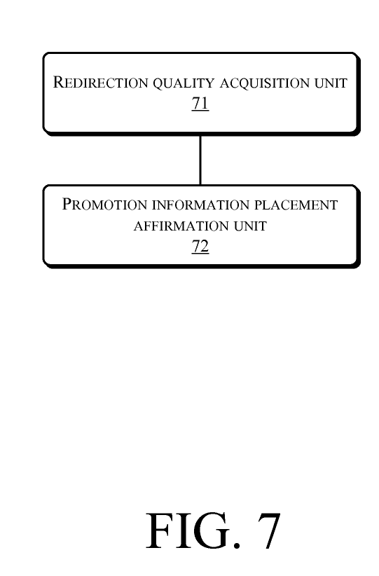

Corresponding to the method of placing promotion information in accordance with the third embodiment of the present disclosure, a fifth embodiment of the present disclosure provides an apparatus of placing promotion information. A structure thereof is shown in FIG. 7, which includes:

a redirection quality acquisition unit 71, configured to obtain a redirection quality of promotion information that is placed by a first website in a second website; and

a promotion information placement affirmation unit 72, configured to affirm continuing a placement of the promotion information in the second website when the redirection quality obtained by the redirection quality acquisition unit 71 meets a pre-determined placement criterion.

The redirection quality of the promotion information is determined by the aforementioned apparatus of determining a redirection quality of promotion information.

A technical person skilled in the art should understand that the embodiments of the present disclosure may be implemented as methods, apparatuses (devices), or products of computer software. Therefore, the present disclosure may be implemented in forms of hardware, software, or a combination of hardware and software. Further, the present disclosure may be implemented in the form of products of computer software executable on one or more computer readable storage media (including but not limited to disk storage device, CD-ROM, optical storage device, etc.) that include computer readable program instructions.

The present disclosure is described in accordance with flowcharts and/or block diagrams of the exemplary methods, apparatuses (devices) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate computer implemented processing. Therefore, the instructions executed by the computer or the other programmable apparatus may be used to implement one or more processes of the flowcharts and/or one or more blocks of the block diagrams.

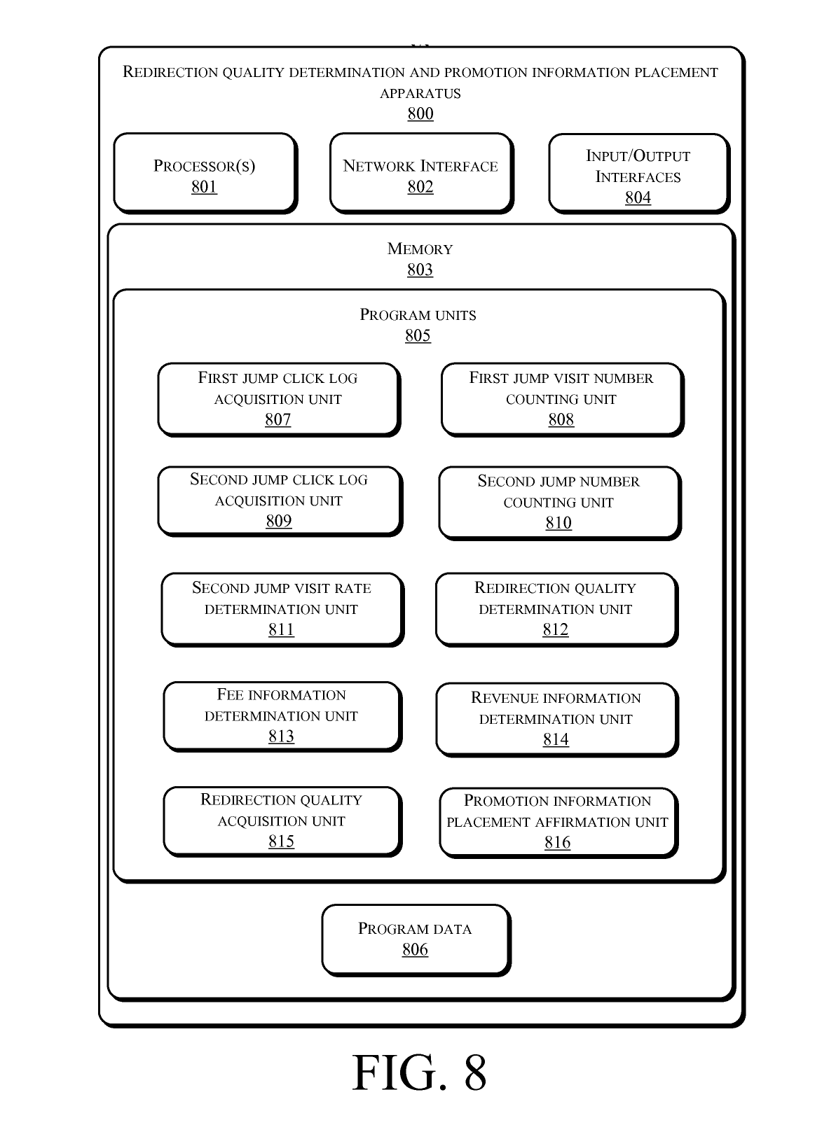

For example, FIG. 8 illustrates an exemplary redirection quality determination and promotion information placement apparatus 800, such as the apparatus as described above, in more detail. In one embodiment, the apparatus 800 can include, but is not limited to, one or more processors 801, a network interface 802, memory 803, and an input/output interface 804.

The memory 803 may include computer-readable media in the form of volatile memory, such as random-access memory (RAM) and/or non-volatile memory, such as read only memory (ROM) or flash RAM. The memory 503 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 803 may include program units 805 and program data 806. In one embodiment, the program units 805 may include a first jump click log acquisition unit 807, a first jump visit number counting unit 808, a second jump click log acquisition unit 809, a second jump visit number counting unit 810, a second jump visit rate determination unit 811, a redirection quality determination unit 812, a fee information determination unit 813, a revenue information determination unit 814, a redirection quality acquisition unit 815 and a promotion information placement affirmation unit 816. Details about these program units and any sub-units and/or modules thereof may be found in the foregoing embodiments described above.

Although preferred embodiments of the present disclosure are provided, a technical person skilled in the art may change and modify theses exemplary embodiments upon understanding the underlying inventive concepts thereof. Therefore, claims attached herein are intended to cover the preferred embodiments and all the changes and modifications that fall into the scope of the present disclosure. A technical person skilled in the art may make changes and modifications of the present application without deviating from the spirit and scope of the present disclosure. If these changes and modifications are within the scope of the claims and their equivalents of the present disclosure, the present disclosure intends to covers such changes and modifications.

What is claimed is:

1. A method of determining a redirection quality of promotion information, comprising:
counting a number of first jump visits that have been redirected by a jump server of a second website to a corresponding promotion web page in a first website through clicking of promotion information displayed at the second website;
counting a number of second jump visits that have been redirected by a click server of the first website to a corresponding transaction web page through clicking of transaction information on the promotion web page;
determining a second jump visit rate for the promotion information based on the counted number of the first jump visits and the counted number of second jump visits; and
determining the redirection quality of the promotion information based on the determined second jump visit rate.

2. The method of claim 1, wherein determining the second jump visit rate comprises:
treating a quotient value between the counted number of second jump visits and the counted number of first jump visits as the second jump visit rate of the promotion information.

3. The method of claim 1, further comprising:
determining a revenue ratio between the first website and the second website with respect to the promotion information based on the second jump visit rate.

4. The method of claim 3, further comprising:
determining fee information corresponding to each second jump visit of the second jump visits;
for each second jump visit, determining revenue information of the first website and the second website with respect to the second jump visit based on the fee information and the revenue ratio.

5. The method of claim 4, further comprising:
obtaining a second jump click log from the click server;
wherein the second jump click log comprises a second jump visit record which is generated each time a user clicks on the transaction information in the promotion web page, and the second jump visit record comprises an identifier of the transaction information that is clicked by the user, an identifier of the promotion information, and a transaction identifier of the transaction web page that corresponds to the transaction information clicked by the user; and
determining the fee information comprises:
obtaining identifiers of all transaction information belonging to the promotion web page;
determining second jump visit records that comprise the identifier of the promotion information of which the redirection quality is to be determined and the identifier of the transaction information from the second jump click log; and
for each determined second jump visit record, calculating fee information of a second jump visit corresponding to the second jump visit record based on the transaction identifier included in the second jump visit record.

6. The method of claim 1, further comprising:
obtaining a first jump click log from the jump server;
and the first jump click log comprises a first jump visit record which is generated each time when a user clicks the promotion information of the first website, and the first jump visit record comprises an identifier of the promotion information clicked by the user; and
counting the number of first jump visits comprises:
counting a number of first jump visit records which include the identifier of the promotion information from the first jump click log; and
treating the counted number of first jump visit records as the number of first jump visits that have been redirected by the jump server to the corresponding promotion web page.

7. The method of claim 1, further comprising:
obtaining a second jump click log from the click server;
wherein the second jump click log comprises a second jump visit record generated each time a user clicks on the transaction information in the promotion web page, and the second jump visit record comprises an identifier of the transaction information clicked by the user and an identifier of the promotion information; and
counting the number of second jump visits comprises:
obtaining identifiers of all transaction information in the promotion web page;
counting a number of second jump visit records that include the identifier of the promotion information of which the redirection quality is to be determined and the identifier of the transaction information;
treating the counted number of second jump visit records as the number of second jump visits that have been redirected by the click server to the corresponding transaction web page due to the clicking of the transaction information on the promotion web page from among the first jump visits that have been redirected by the jump server to the corresponding promotion web page due to the clicking of the promotion information.

8. The method of claim 1, wherein determining the redirection quality of the promotion information comprises:
finding a second jump visit rate range within which the determined second jump visit rate is located from pre-determined second jump visit rate ranges corresponding to a plurality of different redirection qualities; and
treating the located second jump visit rate range as the redirection quality of the promotion information.

9. An apparatus of determining redirection quality of promotion information, comprising:
a first jump visit number counting unit, configured to count a number of first jump visits that have been redirected by a jump server of a first website to a corresponding promotion web page in the first website due to clicking of promotion information displayed in a second website;
a second jump visit number counting unit, configured to count, a number of the second jump visits that have been redirected by a click server of the first website to a corresponding transaction web page due to clicking of transaction information in the promotion web page;
a second jump visit rate determination unit, configured to determine a second jump visit rate of the promotion information based on the number of the first jump visits counted by the first jump visit number counting unit and the number of the second jump visits counted by the second jump visit number counting unit; and
a redirection quality determination unit, configured to determine a redirection quality of the promotion information based on the second jump visit rate determined by the second jump visit rate determination unit.

10. The apparatus of claim 9, wherein the second jump visit rate determination unit is further configured to use a quotient value between the number of the second jump visits counted by the second jump visit counting unit and the number of the first jump visits counted by the first jump visit counting unit as the second jump visit rate of the promotion information.

11. The apparatus of claim 9, further comprising a revenue ratio determination unit that is configured to determine a revenue ratio between the first website and the second website with respect to the promotion information based on the second jump visit rate determined by the second jump visit rate determination unit.

12. The apparatus of claim 11, further comprising:
a fee information determination unit configured to determine fee information corresponding to each second jump visit; and
a revenue information determination unit configured to determine information of respective revenues for the first website and the second website with respect to each second jump visit based on the fee information determined by the fee information determination unit and the revenue ratio determined by the revenue ratio determination unit.

13. The apparatus of claim 9, further comprising:
a second jump click log acquisition unit, configured to obtain a second jump click log from the click server of the first website;
wherein the second jump click log comprises a second jump visit record which is generated each time a user clicks on the transaction information in the promotion web page, and the second jump visit record comprises an identifier of the transaction information that is clicked by the user, an identifier of the promotion information, and a transaction identifier of the transaction web page that corresponds to the transaction information clicked by the user.

14. The apparatus of claim 13, further comprising:
a first transaction information identifier acquisition sub-unit configured to obtain identifiers of all transaction information in the promotion web page;
a second jump visit record determination sub-unit configured to determine the second jump visit records that include the identifier of promotion information of which the redirection quality is to be determined and the identifiers of the transaction information obtained by the first transaction information identifier acquisition unit from the second jump click log that is obtained by the second jump click log acquisition unit; and
a fee information determination sub-unit, configured to, for each second jump visit records determined by the second jump visit record determination sub unit, determine fee information of a second jump visit corresponding to the second jump visit record based on a transaction identifier included in the second jump visit record.

15. The apparatus of claim 9, further comprising:
a first jump click log acquisition unit, configured to obtain a first jump click log from the jump server of the second website;
wherein the first jump visit counting unit comprises:
a first jump visit record counting sub-unit, configured to count a number of the first jump visit records which contain the identifier of the promotion information from the first jump click log; and
a first jump visit number affirmation sub-unit, configured to treat the number of first jump visit records counted by the first jump visit record counting sub-unit as the number of first jump visits redirected by the jump server to the corresponding promotion web page due to the clicking of the promotion information.

16. The apparatus of claim 9, wherein the second jump visit counting unit comprises:
a second service information identifier acquisition sub-unit configured to obtain identifiers of all transaction information on the promotion web page;
a second jump visit records counting sub-unit configured to determine a number of the second jump visit records which contain the identifier of promotion information of which the redirection quality is to be determined and the identifiers of the transaction information; and
a second jump visit number affirmation sub-unit configured to treat the number of the second jump visit records obtained by the second jump visit record counting sub-unit as the number of second jump visits redirected by the click server to the corresponding transaction web page due to the clicking of the transaction information in the promotion web page, from among the first jump visits redirected by the jump server to the corresponding promotion web page due to the clicking of the promotion information.

17. The apparatus of claim 9, wherein the redirection quality determination unit comprises:
a second jump visit rate range searching sub-unit configured to find a second jump visit rate range within which the second jump visit rate determined by the second jump visit rate determination unit is positioned from among pre-determined second jump rate ranges that correspond to various redirection qualities; and
a redirection quality affirmation sub-unit configured to treat the second jump visit rate range found by the second jump visit rate range searching sub-unit as the redirection quality of the promotion information.

18. A method of placing promotion information, comprising:
obtaining a redirection quality of promotion information which has been redirected from a second website to a first website; and
affirming to continue to place the promotion information on the second website when the redirection quality meets a pre-determined placement criterion.

19. The method of claim 18, further comprising determining the redirection quality of the promotion information.

20. The method of claim 19, wherein determining the redirection quality of the promotion information comprises:
obtaining a first jump click log from a jump server of the first website;
counting a number of first jump visits that have been redirected by the jump server to a corresponding promotion web page in the first website through clicking of the promotion information displayed in the second website;
obtaining a second jump click log from a click server of the first website;
based on the obtained second jump click log and from among the first jump visits that have been redirected by the jump server to the corresponding promotion web page through the clicking of the promotion information, counting a number of second jump visits that have been redirected by the click server to a corresponding transaction web page through clicking of transaction information on the promotion web page of the first website;
determining a second jump visit rate for the promotion information based on the counted number of the first jump visits and the counted number of second jump visits; and
determining the redirection quality of the promotion information based on the determined second jump visit rate.
